(19) United States
(12) Patent Application Publication
(10) Pub. No.: US 2015/0291095 A1
(43) Pub. Date: Oct. 15, 2015

(54) LANE DEPARTURE WARNING SYSTEM AND METHOD IN COMBINATION WITH DRIVING BEHAVIOR

(71) Applicant: PAPAGO INC., Taipei City (TW)

(72) Inventors: Liang-Yi CHIEN, Taipei City (TW); Fang-Chu CHOU, Taipei City (TW); Chun-Kai CHANG, Taipei City (TW)

(73) Assignee: PAPAGO INC.

(21) Appl. No.: 14/509,141

(22) Filed: Oct. 8, 2014

(30) Foreign Application Priority Data
Apr. 9, 2014 (TW) 103113032

(51) Int. Cl. B60R 1/00; H04N 7/18

(52) U.S. Cl. CPC B60R 1/00; H04N 7/183; B60R 2300/804; B60R 2300/8093; B60R 2300/10

(57) ABSTRACT

A lane departure warning system and method in combination with a driving behavior are provided. The system is disposed on a vehicle, and includes: at least one first information nation capture unit, for capturing environment information around the vehicle; at least one second information capture unit, disposed in the vehicle, for capturing in-vehicle image information; a processing unit, electrically connected to the first information capture unit and the second information capture unit, where the processing unit uses an environment determining unit to determine an environment condition of the vehicle according to the environment information, so that the processing unit performs an operation process according to the environment information of the first information capture unit and the in-vehicle image information of the second information capture unit, so as to generate an alarm signal; and a warning unit, for receiving the alarm signal to generate a warning action.

### CROSS-REFERENCE TO RELATED APPLICATION

This application claims the benefit of Taiwan Patent Application No. 103113032, filed on Apr. 9, 2014, which is hereby incorporated by reference for all purposes as if fully set forth herein.

### BACKGROUND

1. Technical Field

The present invention relates to a lane departure warning system and method using information inside and outside a vehicle, and in particular, to a lane departure warning system in combination with a driving behavior and using environment information around a vehicle and information in the vehicle.

2. Related Art

Popularization of vehicles brings tremendous convenience for traffic of people, but because of the popularization of the vehicles, vehicles driving on roads are sharply increasing year by year, road traffic conditions become more complicated, and the number of traffic accidents is increasing every year. Therefore, in order to improve driving safety and clarify responsibilities of traffic accidents, many drivers dispose a lane departure annunciator and a driving recorder on their vehicles, the lane departure annunciator is used for making a warning sound when a driving vehicle departs from a lane, so as to warn the driver to be careful and avoid accidents, and the driving recorder is used as a reference for clarifying responsibilities when an accident occurs.

The conventional lane departure annunciator uses a camera to shoot towards the front of a vehicle so as to capture an image of a road shot by the camera, and operates to determine whether a driving direction of the vehicle is departed or not, and if the driving direction is departed excessively, the lane departure annunciator makes a warning sound to warn a driver; the driving recorder uses a camera to shoot towards the front of the vehicle and uses a display disposed in front of a driver's seat to capture a picture shot by the camera, so as to record conditions during driving, and the display displays the picture shot by the camera, so as to be used as a reference for clarifying responsibilities when an accident occurs. Therefore, if the driver intends to achieve both of the objectives, two cameras and one display should be additionally disposed on the vehicle, which is rather space consuming. Moreover, when a driver drives a vehicle, the driver must view rearview mirrors at left and right sides and inside the vehicle frequently; if the display is disposed at some place in front of the driver's seat for being viewed, the driver is more easily distracted, and therefore, the solution is not ideal, and should be improved.

### SUMMARY

The present invention provides a lane departure warning system in combination with a driving behavior and method using environment information around a vehicle and information in the vehicle, so as to assist a driver in driving the vehicle, and improve driving safety.

The present invention provides a lane departure warning system in combination with a driving behavior, which is disposed on a vehicle, and includes an environment determining unit, at least one first information capture unit, at least one second information capture unit, a processing unit, and a warning unit. The first information capture unit captures environment information around the vehicle, the second information capture unit is disposed in the vehicle, and used for capturing in-vehicle image information, the processing unit is electrically connected to the first information capture unit and the second information capture unit, the processing unit uses the environment determining unit to determine an environment condition of the vehicle according to the environment information, so that the processing unit performs an operation process according to the environment information of the first information capture unit and the in-vehicle image information of the second information capture unit, so as to generate an alarm signal, and the warning unit receives the alarm signal to generate a warning action.

In an embodiment of the present invention, the first information capture unit is a camera, the first information capture unit captures and outputs several pieces of image data, and the environment information at least includes a lane line.

In an embodiment of the present invention, the second information capture unit is a camera.

In an embodiment of the present invention, the warning unit is an alarm.

In an embodiment of the present invention, the warning unit is a display,

In an embodiment of the present invention, a speed sensing unit is further included, which is used for sensing a driving speed of the vehicle, and outputting a speed signal for the processing unit to perform the operation process.

The present invention provides a lane departure warning method in combination with a driving behavior, which is applicable to a vehicle, and includes the following steps: first, capturing environment information around the vehicle by using at least one first information capture unit; capturing in-vehicle image information by using at least one second information capture unit disposed in the vehicle; electrically connecting a processing unit to the at least one first information capture unit and the at least one second information capture unit; determining an environment condition of the vehicle by an environment determining unit according to the environment information, so that the processing unit performs an operation process according to the environment information of the first information capture unit and the in-vehicle image information of the second information capture unit, so as to generate an alarm signal; and finally, receiving the alarm signal by a warning unit to generate a warning action.

In an embodiment of the present invention, the step of capturing environment information around the vehicle by using at least one first information capture unit further includes: capturing and outputting several pieces of image data by the first information capture unit, where the environment information at least includes a lane line.

In an embodiment of the present invention, the step of the processing unit performing an operation process according to the environment information of the first information capture unit and the in-vehicle image information of the second information capture unit, so as to generate an alarm signal further includes: providing a speed sensing unit to sense a driving speed of the vehicle, and output a speed signal for the processing unit to perform the operation process.

The present invention adopts the system and method to view driver's conditions in a vehicle and environment factors out of the vehicle, so as to evaluate driving conditions, so that warning may be made at any time according to the environment factors and the driving conditions of the driver. Therefore, requirements of users may be met, thereby improving the safety of road driving.

### BRIEF DESCRIPTION OF THE DRAWINGS

The disclosure will become more fully understood from the detailed description given herein below for illustration only, and thus are not limitative of the disclosure, and wherein:

FIG. 1 is a block diagram of a system according to a first embodiment of the present invention.

FIG. 2 is a block diagram of a system according to a second embodiment of the present invention.

FIG. 3 and FIG. 4 are flow charts of a lane departure warning method matching FIG. 1.

### DETAILED DESCRIPTION

In order to make the features and advantages of the present invention more comprehensible, embodiments are described in detail in the following through accompanying drawings.

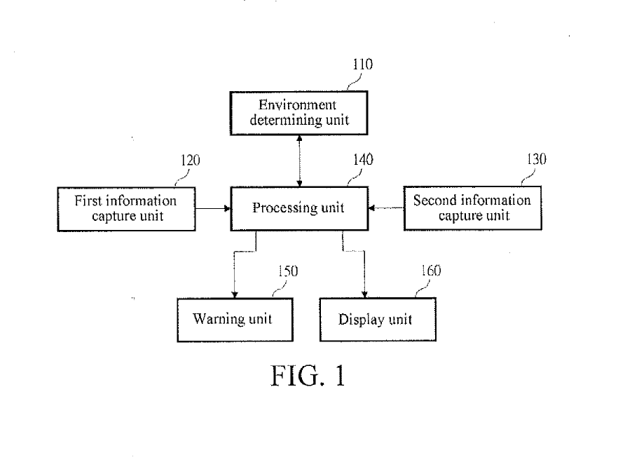

FIG. 1 is a block diagram of a system according to a first embodiment of the present invention. In FIG. 1, a lane departure warning system in combination with a driving behavior is disposed on a vehicle, and includes an environment determining unit 110, at least one first information capture unit 120, at least one second information capture unit 130, a processing unit 140, a warning unit 150, and a display unit 160. The first information capture unit 120 captures environment information around the vehicle, and the second information capture unit 130 is disposed in the vehicle, and used for capturing in-vehicle image information.

The processing unit 140 is electrically connected to the first information capture unit 120 and the second information capture unit 130, and the processing unit 140 uses the environment determining unit 110 to determine an environment condition of the vehicle according to the environment information, so that the processing unit 140 performs an operation process according to the environment information of the first information capture unit 120 and the in-vehicle image information of the second information capture unit 130, so as to generate an alarm signal. The warning unit 150 receives the alarm signal to generate a warning action, and the display unit 160 displays the alarm signal.

In this embodiment, the first information capture unit is a camera, the first information capture unit captures and outputs several pieces of image data, and the environment information at least includes a lane line.

In this embodiment, the second information capture unit is a camera.

In this embodiment, the warning unit is preferably an alarm or a display.

In this embodiment, a speed sensing unit is used for sensing a driving speed of the vehicle, and outputting a speed signal for the processing unit to perform the operation process.

In this embodiment, the environment determining unit may further include a road condition analysis module and a driving behavior analysis module.

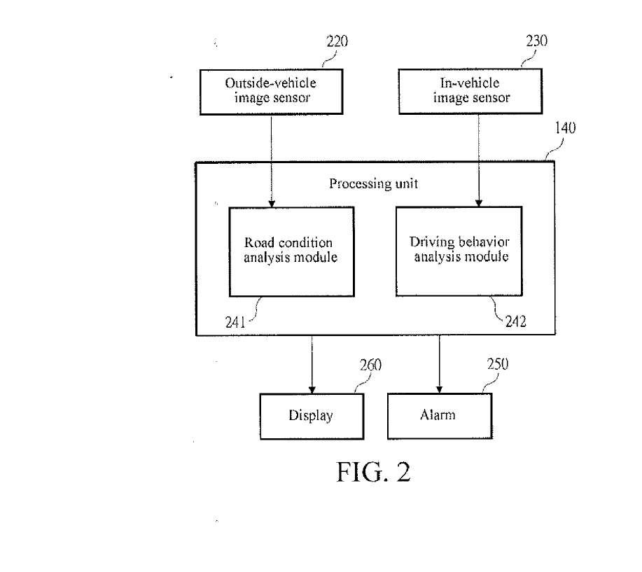

FIG. 2 is a block diagram of a system according to a second embodiment of the present invention. In this embodiment, an outside-vehicle image sensor 220 captures environment information around a vehicle, an in-vehicle image sensor 230 is disposed in the vehicle, so as to capture in-vehicle image information, a processing unit 140 is electrically connected to the outside-vehicle image sensor 220 and the in-vehicle image sensor 230, and the processing unit 140 uses a road condition analysis module 241 to determine an environment condition of the vehicle according to the environment information, and uses a driving behavior analysis module 242 to analyze a driving state of a driver, so that the processing unit 140 performs an operation process according to the environment information of the outside-vehicle image sensor 220 and the in-vehicle image information of the in-vehicle image sensor 230, so as to generate an alarm signal. A display 250 displays the alarm signal, and an alarm 260 generates a warning sound to warn the driver to drive carefully.

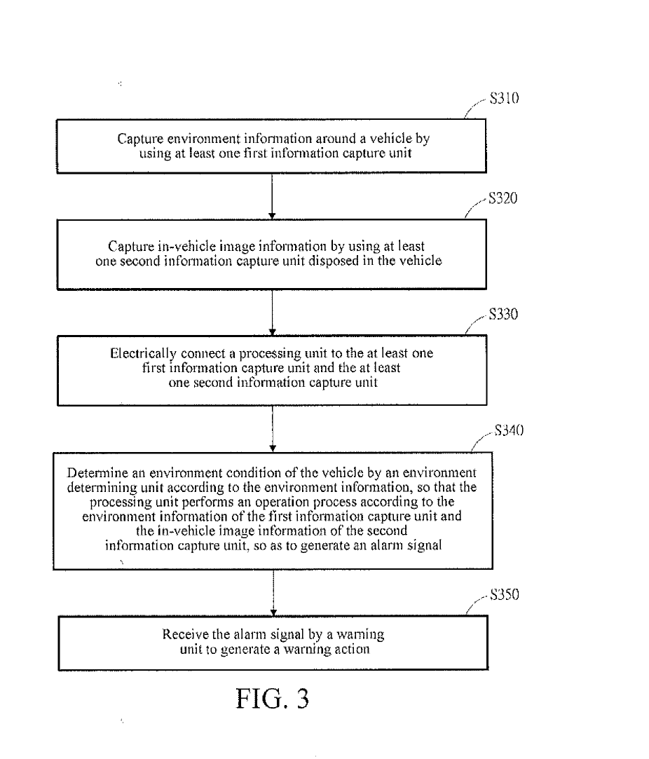

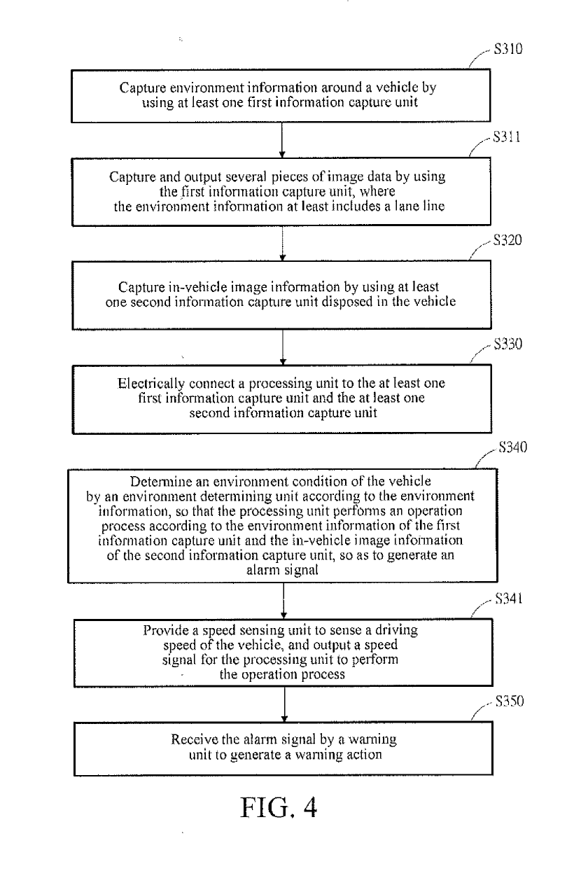

Referring to FIG. 3 and FIG. 4 together, in FIG. 3, a lane departure warning method in combination with a driving behavior is described, which is applicable to a vehicle and includes the following steps: first, capturing environment information around the vehicle by using at least one first information capture unit (step S310), where, the first information capture unit 120 is used for capturing and outputting several pieces of image data, and the environment information at least includes a lane line (step S311); capturing in-vehicle image information by using at least one second information capture unit disposed in the vehicle (step S320); electrically connecting a processing unit to the at least one first information capture unit and the at least one second information capture unit (step S330); and determining an environment condition of the vehicle by an environment determining unit according to the environment information, so that the processing unit performs an operation process according to the environment information of the first information capture unit and the in-vehicle image information of the second information capture unit, so as to generate an alarm signal (step S340), where a speed sensing unit is further provided for sensing a driving speed of the vehicle, and outputting a speed signal for the processing unit 140 to perform the operation process (step S341); and finally, receiving the alarm signal by a warning unit to generate a warning action (step S350).

The embodiments of the present invention are described in the foregoing, but are not intended to limit the present invention, and equivalent replacements such as modifications and improvements made by any person skilled in the art without departing from the spirit and scope of the present invention shall fall within the protection scope of the present invention.

What is claimed is:

1. A lane departure warning system in combination with a driving behavior, disposed on a vehicle, comprising:
an environment determining unit;
at least one first information capture unit, for capturing environment information around the vehicle;
at least one second information capture unit, disposed in the vehicle, for capturing in-vehicle image information;
a processing unit, electrically connected to the at least one first information capture unit and the at least one second information capture unit, wherein the processing unit uses the environment determining unit to determine an environment condition of the vehicle according to the environment information, so that the processing unit performs an operation process according to the environment information of the at least one first information capture unit and the in-vehicle image information of the at least one second information capture unit, so as to genera an alarm signal; and
a warning unit, for receiving the alarm signal to generate a warning action.

2. The lane departure warning system in combination with a driving behavior according to claim 1, wherein the first information capture unit is a camera.

3. The lane departure warning system in combination with a driving behavior according to claim 1, wherein the first information capture unit captures and outputs several pieces of image data, and the environment information at least comprises a lane line.

4. The lane departure warning system in combination with a driving behavior according to claim 1, wherein the second information capture unit is a camera.

5. The lane departure warning system in combination with a driving behavior according to claim 1, wherein the warning unit is an alarm.

6. The lane departure warning system in combination with a driving behavior according to claim 1, wherein the warning unit is a display.

7. The lane departure warning system in combination with a driving behavior according to claim 1, further comprising a speed sensing unit, for sensing a driving speed of the vehicle, and outputting a speed signal for the processing unit to perform the operation process.

8. A lane departure warning method in combination with a driving behavior, applicable to a vehicle, comprising the following steps:
capturing environment information around the vehicle by using at least one first information capture unit;
capturing in-vehicle image information by using at least one second information capture unit disposed in the vehicle;
electrically connecting a processing unit to the at least one first information capture unit and the at least one second information capture unit;
determining an environment condition of the vehicle by using an environment determining unit according to the environment information, so that the processing unit performs an operation process according to the environment information of the at least one first information capture unit and the in-vehicle image information of the at least one second information capture unit, so as to generate an alarm signal; and
receiving the alarm signal by a warning unit to generate a warning action.

9. The lane departure warning method in combination with a driving behavior according to claim 8, wherein the step of capturing environment information around the vehicle by using at least one first information capture unit further comprises:
capturing and outputting several pieces of image data by the first information capture unit, wherein the environment information at least comprises a lane line.

10. The lane departure warning method in combination with a driving behavior according to claim 8, wherein the step of the processing unit performing an operation process according to the environment information of the at least one first information capture unit and the in-vehicle image information of the at least one second information capture unit, so as to generate an alarm signal further comprises:
providing a speed sensing unit to sense a driving speed of the vehicle, and output a speed signal for the processing unit to perform the operation process.
